(19) United States
(12) Patent Application Publication
(10) Pub. No.: US 2008/0202833 A1
(43) Pub. Date: Aug. 28, 2008

(54) Ratchet drive system

(75) Inventor: Robert G. Dickie, Newmarket (CA)

Correspondence Address: SAND & SEBOLT, AEGIS TOWER, SUITE 1100, 4940 MUNSON STREET, NW, CANTON, OH, 44718-3615, US

(73) Assignee: DIASYL INDUSTRIES INC., King City (CA)

(21) Appl. No.: 11/709,387

(22) Filed: Feb. 22, 2007

(51) Int. Cl. B60K 1/00; B60K 17/06

(52) U.S. Cl. 180/65.6; 180/364

(57) ABSTRACT

A drive system for a lightweight electric vehicle comprises a drive train for mounting between an electric motor drive shaft and the vehicle's transaxle to provide a forward driving mode and coasting mode. Preferably, the system is shiftable to provide dynamic braking via the motor and differential and to provide a reverse mode. A motor drive shaft coupler couples with the motor drive shaft and a transaxle coupler couples with the transaxle. In the driving mode, the transaxle coupler rotates with the drive shaft coupler and in the coasting mode rotates relative to the drive shaft coupler in the same direction. A ratchet mechanism provides for the driving and coasting modes. A shifter is movable between an uncoupled position which allows the ratchet mechanism to operate in the coasting mode and a coupled position which overrides the coasting mode operation. The shifter provides for the dynamic braking and reverse mode.

### BACKGROUND OF THE INVENTION

1. Technical Field

The present invention relates generally a vehicle drive system. More particularly, the invention relates to a drive system for a lightweight vehicle which is electrically powered. Specifically, the invention relates to a drive assembly in which the motor and transaxle may be disconnected to allow for coasting and also connectable to produce dynamic braking via the motor and transaxle while additionally providing a reverse mode for the vehicle.

2. Background Information

Various types of electrically powered lightweight vehicles are known in the art such as an electric tricycle. While these vehicles are light in comparison to full size automobiles and the like, they nonetheless usually weigh over 100 lbs. and are typically powered by two full sized car batteries. At speeds below 20 mph, these vehicles have very little air flow friction and likewise relatively minimal rolling friction due to the typical narrow bicycle tires and ball bearing wheels used thereon. Due to this minimal frictional drag, the kinetic energy of these lightweight vehicles when accelerated to a typical full speed of 15-18 mph would allow them to glide for several thousand feet depending on the road conditions. However, to take advantage of this kinetic energy, the electric motor must be operated to at least match the transaxle speed to prevent additional drag created by the highly geared down motor.

U.S. Pat. No. 6,158,542 granted to Nolet utilizes two ratchet mechanisms respectively on each rear wheel of a motorized tricycle to allow it to coast. The ratchet mechanisms are engaged in the drive direction but at soon as the operator releases the throttle, the motor and transaxle drive system completely stop while the wheels continue to spin. One drawback of this invention is that it requires two ratchet mechanisms. In addition, when the operator stops the throttle, the axles and differential gears also stop, thus wasting rotational kinetic energy that might be used to help drive the wheels and coast even further. In addition, this system offers no dynamic braking effect from the motor and drive system because they are effectively disconnected in the coasting mode. These vehicles can obviously build up substantial speed on steep hills and so this becomes a significant safety issue. In addition, the Nolet tricycle is incapable of providing a reverse drive due to the ratchet mechanisms which would only spin without driving the wheels if the motor were reversed. The present invention addresses these and other problems in the art.

### BRIEF SUMMARY OF THE INVENTION

The present invention provides an apparatus comprising a drive train having a driving mode and a coasting mode; a motor drive shaft coupler on the drive train adapted to couple with a drive shaft of a motor; and a transaxle coupler on the drive train adapted to couple with a transaxle and rotationally engaging the drive shaft coupler so that the transaxle coupler is rotatable in a first direction with the drive shaft coupler in the driving mode and rotatable relative to the drive shaft coupler in the first direction in the coasting mode.

### BRIEF DESCRIPTION OF THE SEVERAL VIEWS OF THE DRAWINGS

FIG. 1 is a perspective view of the tricycle with which the drive assembly of the present invention is used.

FIG. 2 is similar to FIG. 1 and shows the box removed from the frame of the tricycle to show the drive assembly mounted on the electric motor and transaxle housing of the rear axle assembly.

FIG. 3 is an enlarged perspective view of the axle assembly showing the drive mechanism mounted on the electric motor and the transaxle housing.

FIG. 4 is an exploded perspective view of the components shown in FIG. 3 and also showing the differential gears and pinion.

FIG. 5 is an enlarged exploded perspective view of the components of the drive assembly.

FIG. 6 is an enlarged exploded perspective view of the ratchet assembly and the pinion coupler.

FIG. 7 is an enlarged sectional view of the drive assembly in the uncoupled position.

FIG. 8 is a sectional view taken on line 8-8 of FIG. 7.

FIG. 9 is a sectional view taken on line 9-9 of FIG. 7 and shows the ratchet assembly in the driving mode.

FIG. 10 is a sectional view taken on line 10-10 of FIG. 7 and shows the ratchet assembly in the ratcheting mode.

FIG. 11 is a sectional view similar to FIG. 7 and shows the drive assembly in the coupled position.

Similar numbers refer to similar parts throughout the drawings.

### DETAILED DESCRIPTION OF THE INVENTION

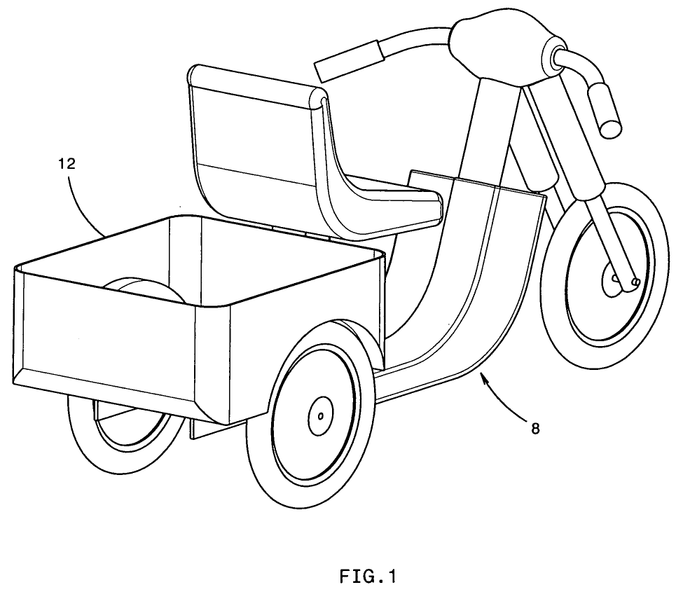

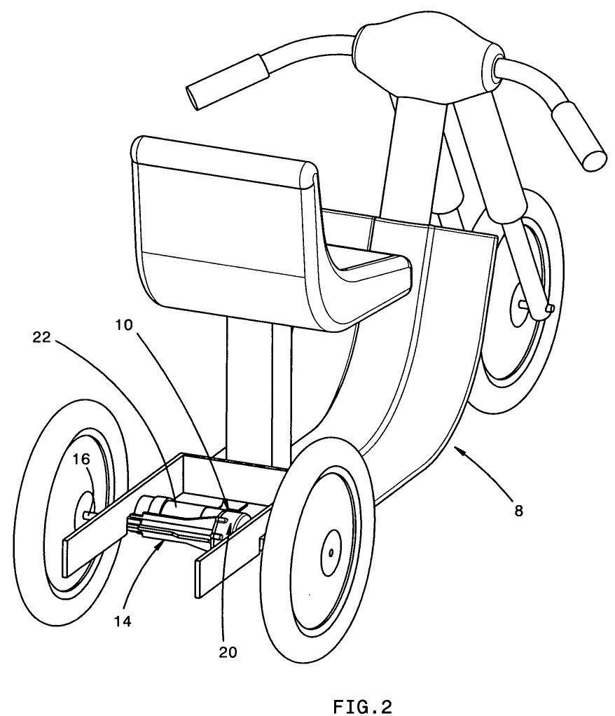

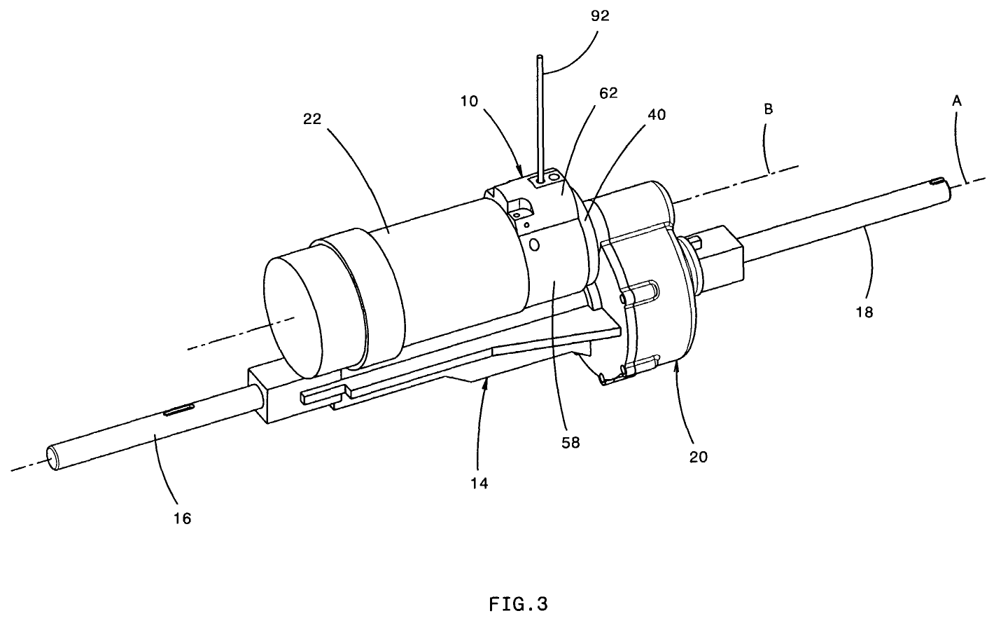

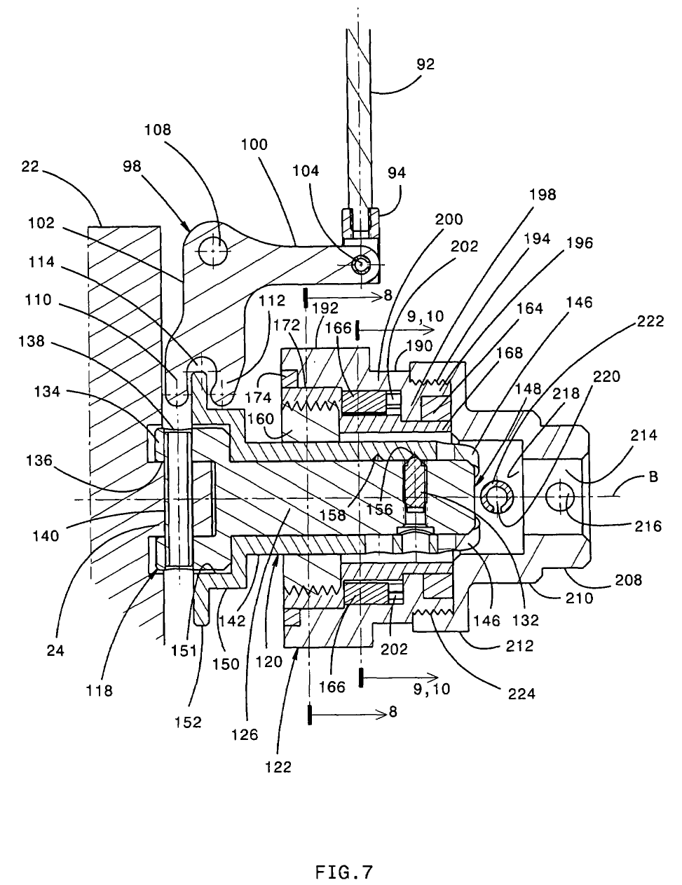

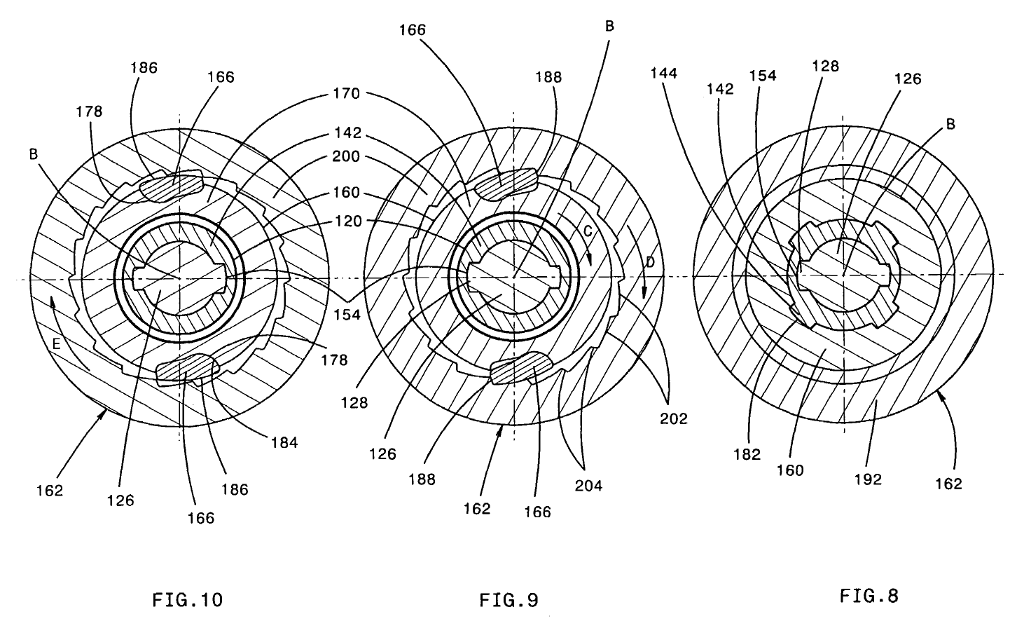

The drive assembly of the present invention is shown generally at 10 in FIGS. 2-4 and is used with a lightweight motorized tricycle 8 shown in FIGS. 1 and 2. Tricycle 8 represents a typical lightweight vehicle and has a frame with a front wheel which is controlled by handlebars, a seat mounted on the frame and a pair of rear wheels mounted on the frame behind the seat. A box 12 is mounted intermediate and generally above the rear wheels as shown in FIG. 1. In FIG. 2, box 12 is removed to show the axle assembly mounted on the frame between the rear wheels. As shown in FIGS. 2 and 3, a transaxle housing 14 is mounted on the frame of tricycle 8 with first and second axles 16 and 18 extending outwardly therefrom in opposite directions and rotatably mounted thereon about a first axis A. The two rear wheels of tricycle 8 are mounted respectively on axles 16 and 18 and driven thereby. Housing 14 includes a differential enclosure 20 on which drive assembly 10 is mounted. An electric motor 22 is connected to drive assembly 10 with assembly 10 between motor 22 and enclosure 20. Motor 22 includes a housing in which a drive shaft 24 (FIG. 7) is rotatably mounted about a second axis B which is parallel to axis A. Motor 22 is powered by an onboard battery (not shown).

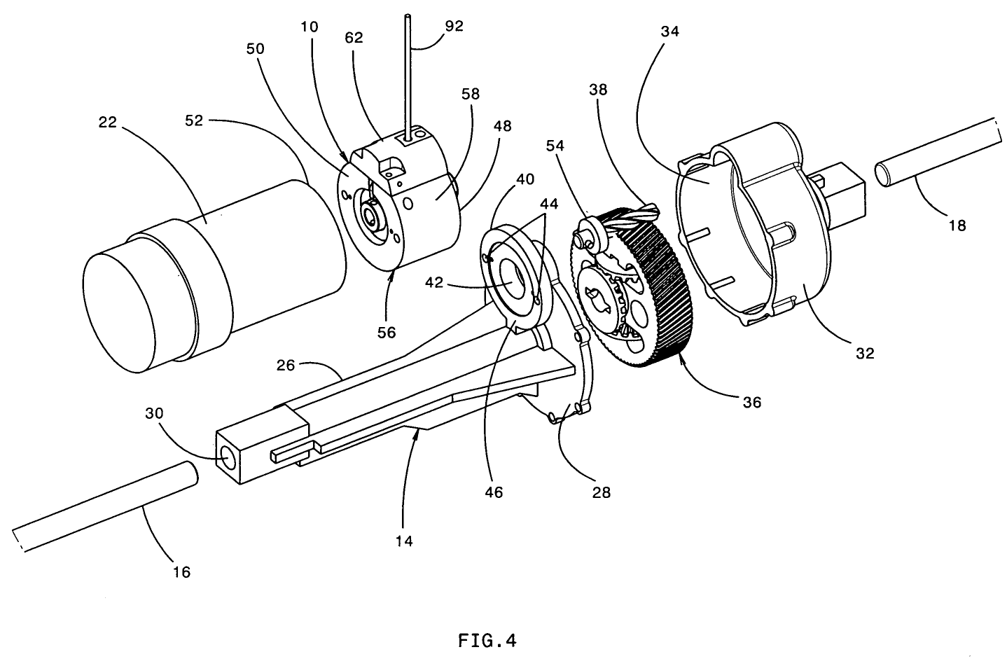

Transaxle housing 14 includes first and second segments which are shown separated from one another in FIG. 4 and attached to another in FIG. 3 by a plurality of bolts. The first segment is an elongated portion 26 having a flange 28 which extends radially outwardly therefrom and forms part of differential enclosure 20. A through bore 30 is formed in portion 26 and flange 28 for receiving therein first axle 16. The second section of housing 14 includes a cup-shaped member 32 defining an interior chamber 34 in which is received a set of differential gears 36 and a pinion 38 which rotatably and drivingly engages gears 36. Another through bore (not shown) similar to bore 30 is formed in the second section of housing 14 and communicates with interior chamber 34 for receiving therein second axle 18. Differential gears 36 drive axles 16 and 18 and allow them to turn at different rates as is well known in the art.

An annular mounting flange 40 is rigidly connected to radial flange 28 and has a central bore 42 formed therethrough which communicates with interior chamber 34 when housing 14 is assembled. A pair of mounting holes 44 is formed in flange 40 for receiving therein fasteners such as bolts (not shown) for mounting thereto drive assembly 10 and motor 22. Flange 40 has a flat circular mounting surface 46 which mates with a flat circular mounting surface 48 of drive assembly 10. Likewise, assembly 10 has a second mounting surface 50 which mates with mounting surface 52 of the housing of motor 22. Drive pinion 38 has a coupling end 54 which is disposed in central bore 42 of flange 40 when assembled so that pinion 38 is rotatably mounted within flange 40 about axis B (FIG. 3).

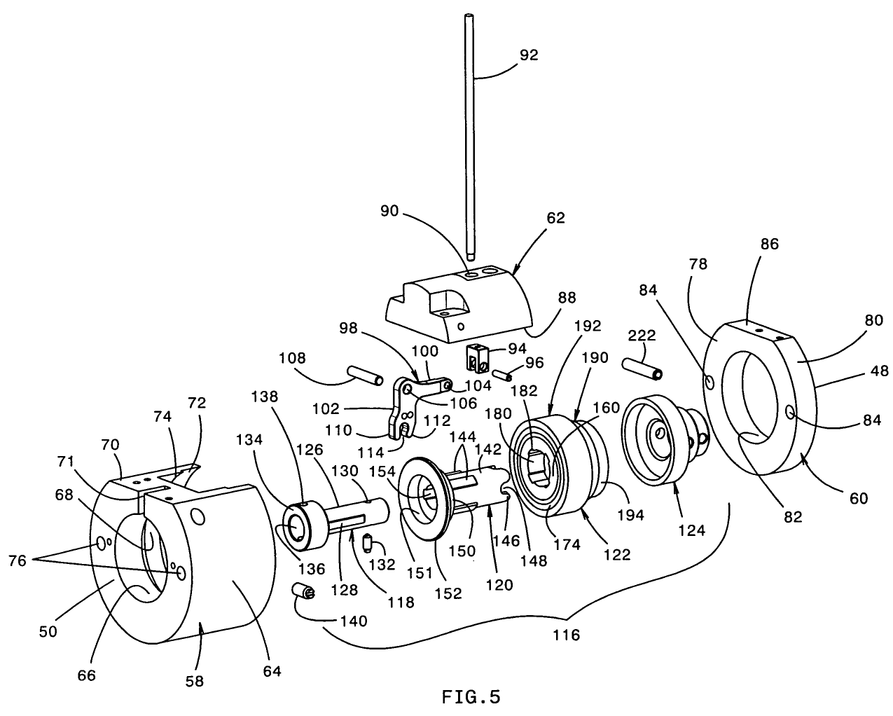

In accordance with the invention and with reference to FIGS. 4 and 5, drive assembly 10 is described in further detail.

Assembly 10 includes a housing 56 including three main components. More particularly, housing 56 includes a generally cylindrical main member 58, an annular end cap 60 (FIG. 5) which is generally circular, and a top cover 62 each of which is connected to the other when assembled. Main member 58 includes a generally cylindrical side wall 64 and an end wall 66 or flange which extends radially inwardly therefrom and includes mounting surface 50 at a first end of member 58. Mounting holes 76 are formed through end wall 66. Interior chamber 68 is formed within side wall 64 and end wall 66. Side wall 64 and end wall 66 are truncated by a flat upper surface 70 so that a portion of interior chamber 68 opens upwardly to communicate with surface 70. A slot 71 is formed in end wall 66 which extends downwardly from upper surface 70 and inwardly from mounting surface 50 and communicates with interior chamber 68. Side wall 64 at an end opposite mounting surface 50 has a circular inner surface 72 and is stepped inwardly to form an annular stop 74 which extends radially inwardly from surface 72.

As shown in FIG. 5, end cap 60 includes mounting surface 48 and has an opposed flat and substantially circular surface 78. End cap 60 further includes a cylindrical outer surface 80 and cylindrical inner surface 82 each of which extends between surfaces 48 and 78. A pair of mounting holes 84 extends through end cap 60 from surface 48 to surface 78 and align with holes 76. When assembled, end cap 60 slides into a portion of interior chamber 68 of main member 58 so that outer surface 80 is flush against inner surface 72 and an outer portion of surface 78 abuts stop 74. End cap 60 has a flat upper surface 86 which is coplanar with upper surface 70 when housing 56 is assembled.

Top cover 62 has an arched upper surface and a flat lower surface 88 which abuts upper surfaces 70 and 86 of member 58 and cap 60 when assembled. Top cover 62 is typically connected to member 58 and end cap 60 by screws or bolts extending into holes formed in top surfaces 70 and 86. Top cover 62 defines an interior chamber (not shown) and includes a cable receiving hole 90 which communicates with side interior chamber for receiving therethrough an actuating cable 92. The lower end of cable 92 is connected to a mounting clevis 94 which has a pair of spaced arms with holes formed therein for receiving a cylindrical pivot 96.

A shifter arm 98 includes first and second legs 100 and 102 which are connected and extend generally perpendicularly to one another. A hole 104 is formed in first leg 100 for receiving therethrough pivot 96 when first leg 100 is disposed between the arms of mounting clevis 94 so that leg 100 is pivotally connected to mounting clevis 94. Another hole 106 is formed in shifter arm 98 adjacent the intersection of first and second legs 100 and 102 for receiving therethrough another pivot 108 which is mountable internally on top cover 62 so that shifter arm 98 is pivotally mounted on top cover 62 via pivot 108. Second leg 102 includes first and second spaced fingers 110 and 112 defining there between a recess or space 114.

In accordance with the invention, drive assembly 10 includes a drive train 116 indicated generally by the bracket in FIG. 5. Drive train 116 has four major components, namely a motor drive shaft coupler 118, a shifter 120, a ratchet mechanism 122 and a differential or pinion coupler 124. Drive train 116 is rotatable about axis B and is thus coaxial with drive shaft 24 (FIG. 7) and pinion 38 (FIG. 4). Drive train 116 has a driving mode (FIG. 9) and a coasting mode (FIG. 10) which are discussed further below. Drive train 116 is disposed within housing 56 but is not in contact therewith when mounted on tricycle 8. In part, housing 58 serves as a spacer or extender which is rigidly mounted on motor 22 and flange 40 in order to provide sufficient space for drive train 116 to extend between motor 22 and pinion 38. Top cover 62 of housing 56 also provides a support for the movable attachment of shifter arm 98 and cable 92.

Motor coupler 118 serves as an input of the drive train which is coupled with or rotationally engaged with drive shaft 24 (FIG. 7) of motor 22. Pinion coupler 124 serves as an output of drive train 116 which couples with and rotationally engages coupling end 54 of pinion 38 (FIG. 4). Thus, drive shaft 24 of motor 22 rotationally engages motor coupler 118 to provide rotational engagement with pinion coupler 124 via shifter 120 and/or ratchet mechanism 122 (in the driving mode) to provide rotational output at coupler 124. It is noted, however, that pinion coupler 124 may serve as an input and motor coupler 118 may serve as an output when axles 16 and 18 are rotating faster than a rotational input of drive shaft 24 so that the driving force is applied in a reverse direction, as will be discussed further below.

Motor coupler 118 includes an elongated cylindrical shaft 126 with splines or keys 128 extending outwardly therefrom. A hole 130 is formed in shaft 126 for receiving therein a spring-biased detent 132. An enlarged coupling head 134 is connected to shaft 126 and defines a cavity 136 for receiving therein an end of drive shaft 124 of motor 22. A threaded hole 138 is formed in head 134 for receiving therein a screw or threaded pin 140 for mounting drive shaft 24 to coupler 118.

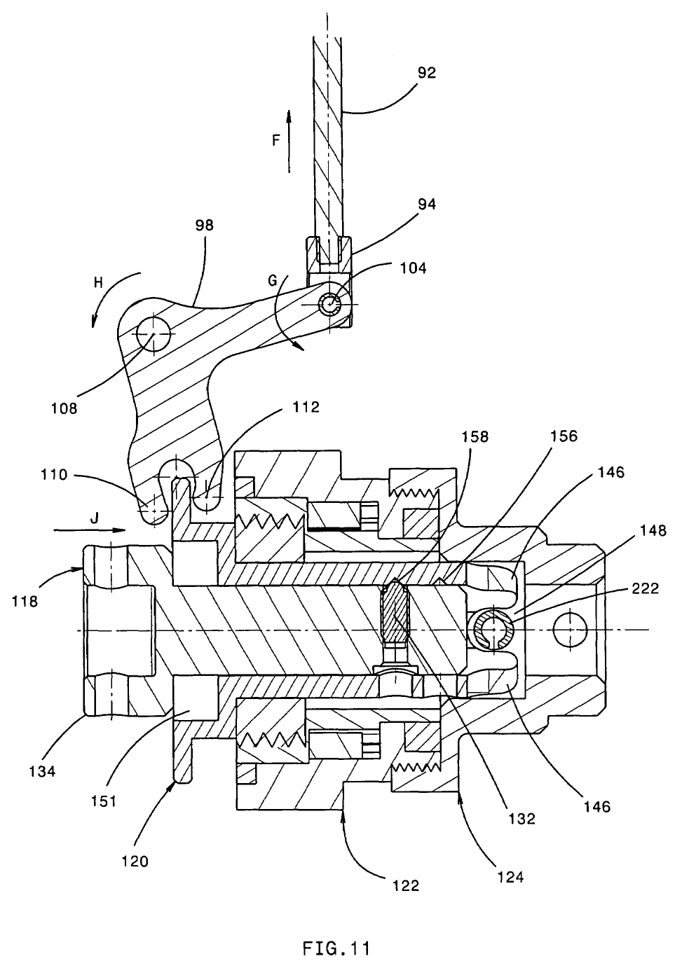

Shifter 120 includes a tubular structure having a cylindrical side wall 142 with splines or keys 144 extending radially outwardly therefrom. Four engaging projections 146 extend axially outwardly from an end of side wall 142 and define there between respective cutouts or recesses 148. A cup-shaped collar 150 extends radially outwardly from side wall 142 at an end opposite projections 146 and defines therein a cavity 151. An annular flange 152 extends radially outwardly from collar 150 and is received in space 114 between fingers 110 and 112 of shifter arm 98, as shown in FIG. 7. Internal splines are formed on the surface of side wall 142 or key ways 154 are formed therein for slidably receiving therein keys 128. Shaft 126 is thus slidably received in the axial direction within the interior chamber defined by side wall 142. A portion of coupling head 134 is receivable within cavity 151 as shown in FIG. 7. As also shown in FIG. 7, first and second axially spaced detent notches 156 and 158 are formed in side wall 142 extending outwardly from the inner surface thereof. The tip of detent 132 is received in first notch 156 when shifter 120 is in the uncoupled position shown in FIG. 7 and received in second notch 158 when the shifter is in the coupled position shown in FIG. 11.

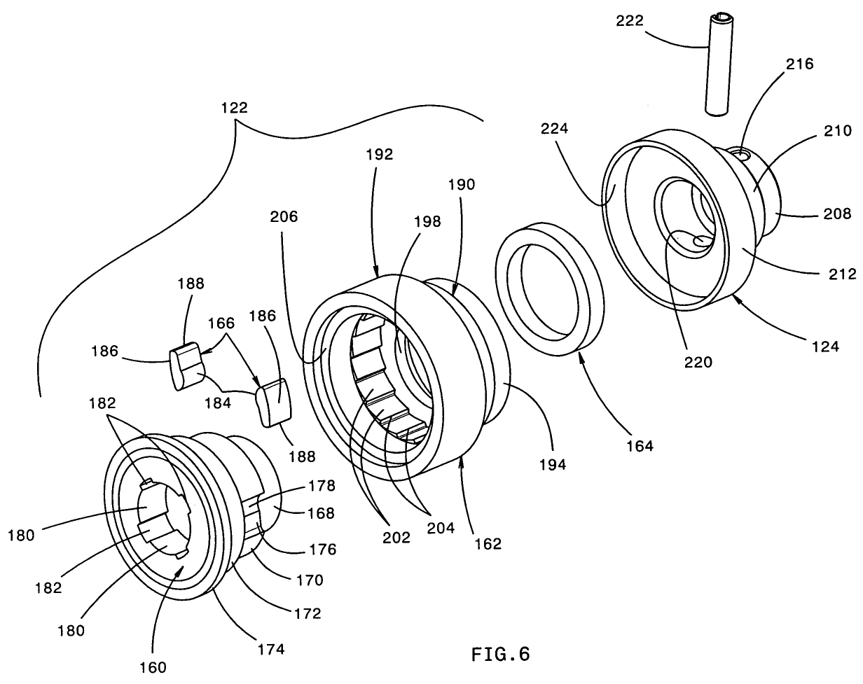

In accordance with the invention and with reference to FIGS. 5-7, ratchet mechanism 122 is described in further detail. Ratchet mechanism 122 includes a pair of ratchet members in the form of a hub 160 and an outer sleeve 162 which received therein hub 160. A bearing 164 is mounted on each of hub 160 and sleeve 162 whereby hub 160 and sleeve 162 are rotatable about axis B relative to one another. Ratchet mechanism 122 further includes a pair of pawls 166. Hub 160 includes several generally cylindrical sections including a bearing support 168 having an outer surface on which the inner surface of bearing 164 is mounted. Hub 160 steps outwardly from support 168 to a pawl-mounting ring 170. A pair of pawl-receiving recesses 176 are formed in ring 170 extending inwardly from the outer surface thereof for receiving pawls 166 therein. A concave arcuate surface 178 bounds each recess 176. Hub 160 steps outwardly from ring 170 to a bearing support 172 on which a bearing 174 is mounted. Hub 160 has an internal splined section comprising splines or keys 180 alternating with key ways 182 which receive therein splines or keys 144 of shifter 120 whereby shifter 120 rotationally engages and is axially slidable relative to ratchet mechanism 122.

Outer sleeve 162 includes a generally cylindrical side wall having a smaller diameter section 190 which steps outwardly to a larger diameter section 192. Section 190 includes an externally threaded portion 194 on a cylindrical bearing support 196 within which bearing 164 is received. An annular flange 198 extends radially inwardly from support 196 and abuts bearing 164. The sidewall steps inwardly from flange 196 to a ratchet wall 200 having a series of internal one-way ratchet teeth 202 extending radially inwardly therefrom. Each tooth 202 has an engaging or drive surface 204 which is drivingly engagable with drive surfaces 188 of pawls 166 when hub 160 and outer sleeve 162 are rotated in a driving direction. Sliding surface 186 of pawls 166 are slidable along the outer surfaces of teeth 202 when hub 160 and sleeve 162 are rotated in an opposite ratcheting direction. Sidewall section 192 steps outwardly to form a bearing recess 206 in which bearing 174 is received to rotatably support sleeve 162 on hub 160 along with bearing 164.

Coupler 124 is a generally tubular member having a stepped sidewall including a first sidewall section 208, a second sidewall section 210 stepped outwardly from section 208 and a third sidewall section 212 stepped outwardly from section 210. A coupling cavity 214 (FIG. 7) is formed in first section 208 for receiving therein coupling end 54 of pinion 38 (FIG. 4). A hole 216 is formed in section 214 for receiving the pin on coupling end 54 to connect pinion 38 to coupler 124. Second section 210 defines a larger bore cavity 218 for receiving engaging projections 146 therein. A hole 220 is formed in second section 210 and communicates with cavity 218 for receiving therethrough a drive pin 222 which is received in a pair of opposed recesses 148 between respective pairs of adjacent projections 146 when shifter 120 is in the coupled position shown in FIG. 11. Third sidewall section 212 has an internally threaded portion 224 which threadably engages threaded portion 194 of outer sleeve 162 to join coupler 124 and sleeve 162.

The operation of drive assembly 10 is now described with reference to FIGS. 7 and 9-11. In the uncoupled position shown in FIG. 7, motor 22 is operated to rotate drive shaft 24 which in turn rotates motor coupler 118, shifter 120 and hub 160 via the various spline engagements there between. This rotational motion is shown by arrow C in FIG. 9, which illustrates the driving mode. This driving torque is translated from hub 160 to outer sleeve 162 via the engagement of pawls 166 with ratchet teeth 202 so that outer sleeve 162 rotates as shown at arrow D in FIG. 9. This rotational torque is translated to pinion coupler 124 and thereby pinion 38 to drive differential gears 36 in a standard manner to drive axles 16 and 18 and the corresponding rear wheels of tricycle 8.

The coasting mode, on the other hand, is illustrated in FIG. 10. This occurs when the wheel speed of tricycle 8 and rotation of its rear wheels is sufficiently high to cause pinion 38, coupler 124 and outer sleeve 162 to rotate faster than the rotational speed of drive shaft 24 of motor 22. This causes ratchet mechanism 122 to enter a ratcheting or skipping mode in which outer sleeve 162 continues to rotate in the same direction as indicated at arrow E but at a speed which is faster than any rotation of hub 160. Thus, pawls 166 slide along the inner surfaces of teeth 202 to allow for the coasting of tricycle 8 without the drag which would otherwise be created by the force necessary to rotate drive shaft 24 of motor 22. This allows for the efficient coasting of tricycle 8 while motor 22 may be stopped altogether to preserve the charge on the battery which powers motor 22.

When desired, the operator of tricycle 8 may shift drive assembly 10 to the coupled position shown in FIG. 11. Typically, a manually operable shift lever or the like is attached to cable 92 which the operator can manipulate in order to apply a force to move it as indicated at arrow F in FIG. 11, causing shifter arm 98 to pivot about pivots 104 and 108 as shown respectively at arrows G and H so that first leg 110 slides shifter 120 axially as indicated at arrow J relative to the other members of drive train 116 so that drive pin 222 is received in a pair of recesses 148 between adjacent pairs of engaging projections 146. During this movement, detent notch 156 moves out of engagement with detent 132 and detent notch 158 moves into engagement with detent 132.

In the coupled position, engaging projections 146 drivingly engage drive pin 222 to directly drive pinion coupler 124 and to eliminate the ability of outer sleeve 122 to rotate relative to hub 160 so that the ratcheting or skipping mode discusses with reference to FIG. 10 is no longer available. This allows the transaxle and motor to provide dynamic braking to help slow tricycle 8 due to the force applied by motor 22 to the highly geared transaxle, which is commonly geared at a ratio of about 20:1. More particularly and as previously noted, pinion coupler 124 serves as the input of drive train 116 so that rotational force from the rear wheels and axles of tricycle 8 rotates coupler 124 to drivingly rotate shifter 120 via engagement of pin 222 and projection 146. In turn, shifter 120 drivingly rotates motor coupler 118 and drive shaft 24 against any force applied by motor 22 via shaft 24. In addition, the coupled mode allows for the reversal of the polarity of the DC motor 22 so that it may be run in reverse in order to drive tricycle 8 rearwardly, which is not possible in the uncoupled position due to the ratcheting mode of ratchet mechanism 122. In this reverse mode, drive shaft 24 rotates in the reverse direction to respectively drive motor coupler 118, shifter 120 and pinion coupler 124 via pin 222 in the direction opposite that shown by arrows C and D in FIG. 9.

Drive train 116 thus provides for a forward driving mode and coasting mode, the latter of which may be overridden by the coupled position of shifter 120 to provide for dynamic braking as well as a reverse mode.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An apparatus comprising:
a drive train having a driving mode and a coasting mode;
a motor drive shaft coupler on the drive train adapted to couple with a drive shaft of a motor; and
a transaxle coupler on the drive train adapted to couple with a transaxle and rotationally engaging the drive shaft coupler so that the transaxle coupler is rotatable in a first direction with the drive shaft coupler in the driving mode and rotatable relative to the drive shaft coupler in the first direction in the coasting mode.

2. The apparatus of claim 1 further comprising a ratchet mechanism on the drive train configured to provide the driving and coasting modes.

3. The apparatus of claim 1 further comprising a shifter on the drive train movable between a first position in which the transaxle coupler is rotatable relative to the drive shaft coupler in the first direction and a second position in which the transaxle coupler is not rotatable relative to the drive shaft coupler in the first direction.

4. The apparatus of claim 3 wherein the drive train rotates about a first axis; and the shifter is axially movable between the first and second positions.

5. The apparatus of claim 4 wherein the shifter slidably engages one of the couplers.

6. The apparatus of claim 3 further comprising a shifting mechanism configured to move the shifter between the first and second positions.

7. The apparatus of claim 6 further comprising an annular flange on the shifter; and a pair of spaced fingers on the shifting mechanism which receive therebetween the annular flange.

8. The apparatus of claim 6 further comprising a drive train housing in which the drive train is disposed; and wherein the shifting mechanism is mounted on the housing.

9. The apparatus of claim 8 further comprising a shifter arm movably mounted on the housing and contacting the shifter for moving the shifter between the first and second positions.

10. The apparatus of claim 9 further comprising an actuating cable mounted on the shifter arm.

11. The apparatus of claim 3 further comprising a ratchet mechanism mounted on the shifter configured to provide the driving and coasting modes.

12. The apparatus of claim 1 further comprising a shifter on the drive train movable between first and second positions; wherein one of the couplers abuts the shifter in the first and second positions; and the other of the couplers respectively abuts and does not abut the shifter in the first and second positions.

13. The apparatus of claim 12 further comprising a through bore formed in the shifter which receives therein the one of the couplers.

14. The apparatus of claim 13 further comprising a cavity formed in the other of the couplers which receives therein the shifter in the first position.

15. The apparatus of claim 1 further comprising a drive train housing having a motor connection end adapted to connect to the motor and a transaxle connection end adapted to connect to the transaxle; and wherein the drive train is disposed in the housing.

16. The apparatus of claim 15 wherein the drive train does not contact the housing.

17. The apparatus of claim 1 further comprising an electric motor; a drive shaft on the motor; and a transaxle; wherein the drive shaft coupler is coupled with the drive shaft; and the transaxle coupler is coupled with the transaxle.

18. The apparatus of claim 17 wherein the transaxle comprises a pinion; and the transaxle coupler is coupled with the pinion.

19. The apparatus of claim 18 wherein the transaxle comprises a differential; and the pinion drivingly engages the differential.

20. The apparatus of claim 17 wherein the transaxle comprises an axle rotatable about a first axis; and the drive train is rotatable about a second axis parallel to and offset from the first axis.
